(19) United States
(12) Patent Application Publication
(10) Pub. No.: US 2007/0223674 A1
(43) Pub. Date: Sep. 27, 2007

(54) ENDPOINT INITIATION OF MULTIPART CONFERENCES

(75) Inventor: Odd Arild SKAFLESTAD, Oslo (NO)

Correspondence Address: OBLON, SPIVAK, MCCLELLAND, MAIER & NEUSTADT, P.C., 1940 DUKE STREET, ALEXANDRIA, VA, 22314, US

(73) Assignee: Tandberg Telecom AS, Lysaker (NO)

(21) Appl. No.: 11/675,966

(22) Filed: Feb. 16, 2007

(30) Foreign Application Priority Data
Feb. 22, 2006 (NO) 20060861

(51) Int. Cl. H04M 3/42

(52) U.S. Cl. 379/202.01

(57) ABSTRACT

The invention discloses a method in an MCU for enabling intuitive endpoint initiation of a multipart conference. According to the invention, a number of conference numbers are pre-allocated and stored in the MCU. When dialling one of these numbers from an endpoint, a call will be routed to the MCU. Upon discovering that the call is addressing a conference number, the MCU establishes multipart conference temporarily including the initiating endpoint only. All endpoints calling the same conference number will then be included in the conference through the MCU and given the required MCU resources.

### FIELD OF THE INVENTION

The present invention relates to a method for ad hoc endpoint initiation of a multipart conference.

### BACKGROUND OF THE INVENTION

There are a number of technological systems available for arranging meeting between participants located in different areas. These systems may include audio visual multipoint conferences or videoconferencing, web conferencing and audio conferencing.

The most realistic substitute of real meetings is high-end videoconferencing systems. Conventional videoconferencing systems comprise a number of end-points communicating real-time video, audio and/or data streams over and between various networks such as WAN, LAN and circuit switched networks. The end-points include one or more monitor(s), camera(s), microphone(s) and/or data capture device(s) and a codec. Said codec encodes and decodes outgoing and incoming streams, respectively.

Traditional Audio Visual Multipoint conferences have a central Multipoint Control Unit (MCU) with three or more endpoints connected. These MCU's perform switching functions to allow the audiovisual terminals to intercommunicate in a conference. The central function of an MCU is to link multiple video teleconferencing sites (EP-endpoints) together by receiving frames of digital signals from audiovisual terminals (EP), processing the received signals, and retransmitting the processed signals to appropriate audiovisual terminals (EP) as frames of digital signals. The digital signals may include audio, video, data and control information. Video signals from two or more audiovisual terminals (EP) can be spatially mixed to form a composite video signal for viewing by teleconference participants. One example of mixing and transcoding is converting four QCIF video streams into one CIF video stream.

When the different video streams have been mixed together into one single video stream the composed video stream is transmitted to the different parties of the video conference, where each transmitted video stream preferably follows a set scheme indicating who will receive what video stream. In general, the different users prefer to receive different video streams. This result in that the multi point control unit needs to perform a large amount, of video mixing, which in turn results in a large demand for processing power.

In order to form such a composed video stream, the conventional solution is to decode the separate incoming video streams from the respective parties, mix the video streams in accordance with the set schemes for the different users and then encode the composite images and transmit it to the respective users from the MCU. Thus, MCU's are provided with a set of encoders and decoders. One decoder is required for each incoming coded bit stream, whereas encoders usually can be shared among several outgoing bit streams. Hence, the required encoder resources in an MCU are usually less than the required decoder resources.

This requires a certain amount of processing power and inputs/outputs assigned to each conference, making the MCU unavailable for new conferences when ongoing conferences already occupies the resources in the MCU.

To provide multipart conferences without MCU, some video endpoints do have integrated MCU features. These are typically meeting room applications, and more expensive conferencing systems. There are also a set of conferencing bridges that enables video multi point conferencing. Both these solutions (Meeting Rooms, Conferencing Bridges) do require conference setup actions, prior to every meeting. This is typically to book a room, schedule the meeting in an administration interface, distribute information, notifying the conference number etc), which typically is done through a user interface of a Management System. This may make the process of hosting a multipoint conferencing event a time consuming task, and the threshold for using this technology to high.

In an environment where personal endpoints are widespread, the usual configuration is small video systems, incapable of hosting a multipoint conference. This does not mean that the need for multipoint visual conferencing is absent. According to prior art, is it not possible to utilize the personal single call video endpoints for multipoint video conferencing, without doing extra management and time consuming preparations.

### SUMMARY OF THE INVENTION

It is an object of the present invention to provide a method that eliminates the drawbacks described above. The features defined in the independent claim enclosed characterize this method.

In particular, the present invention provides a method for establishing a conference between two or more multimedia terminals through a Multipoint Control Unit (MCU), comprising at least the steps of pre-assigning and storing in the MCU one or more conference numbers respectively associated with a user or a multimedia terminal, when a primary multimedia terminal initiates a first call by dialling a first conference number among said one or more conference numbers, then routing said call to the MCU, when the MCU receives said first call, then allocating primary MCU resources and establishing the multipart conference including said primary multimedia terminal, and when a secondary multimedia terminal initiates a succeeding call by dialling said first conference number, then routing said succeeding call to the MCU, allocating secondary resources and including said secondary multimedia terminal in the multipart conference.

### BRIEF DESCRIPTION OF THE DRAWINGS.

In order to make the invention more readily understandable, the discussion that follows will refer to the accompanying drawings.

FIG. 1 is an illustration of video conferencing endpoints connected to an MCU,

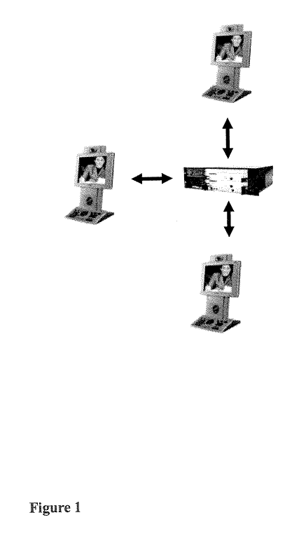

FIG. 2 is a flow chart illustrating the steps in one embodiment of the present invention.

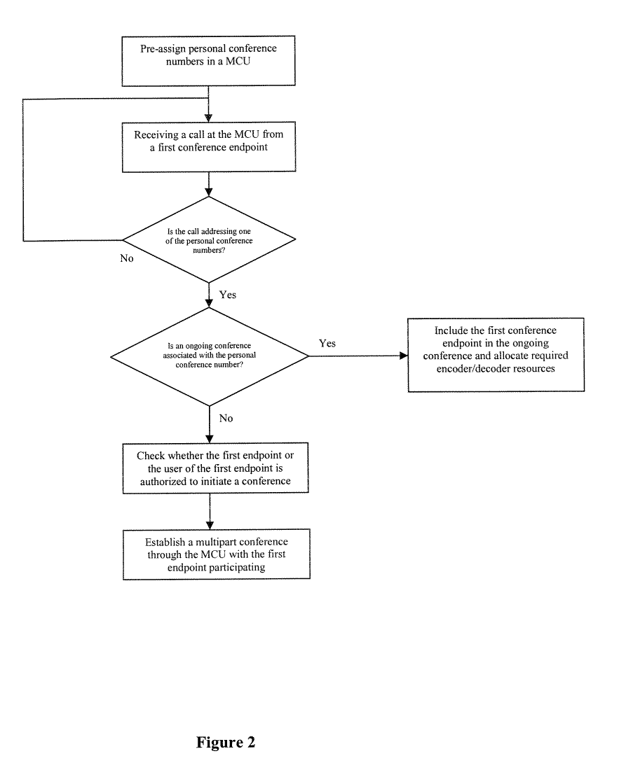

### DETAILED DESCRIPTION OF THE INVENTION.

In the following, the present invention is described by means of one example embodiment. However, people skilled in the art will also realize other implementations and variations within the scope of the invention.

The main idea of the present invention is to utilize central video processing resources, in for example an MCU, to offer multipoint capabilities available for all users, without demanding setup schemes, booking and education of users. According to one embodiment of the invention, a number of users can be registered in an MCU, every registered user is then assigned a unique and personal static number in the MCU.This number is assigned to a person, and not a video system, making a multipoint call available at all times, from any kind of system. All personal numbers are stored in the MCU after being registered. The user may be allocated number for multiple protocols, so the personal multipoint call may serve as a protocol gateway as well (SIP, ISDN, H323). The personal conference number allows multiple user to have an own and unique conference number. When a user dial this number, there will automatically be allocated resources for a conference, into which other users will be connected by dialling the same number. The personal conference number is static, and can be compared to any other personal number such as cellular phone number, pager number etc. This makes this number easy distributable. The number of personal Conference number assigned can be much larger than the required capacity if all numbers personal conference numbers where in use simultaneously. This is due to the conventional traffic theory of the relationship between the number of potential users and the expected value of the number of simultaneous users.

However, the personal conference number is not to be confused with a phone number, as it is not used for reaching a certain terminal. The solution will utilize free capacity on the MCU in an ad-hoc fashion, and will allocate and de allocate resources dynamically.

When a user calls his/her personal conference number, the call will be routed to the MCU where the number is stored. This is accomplished by e.g. giving all personal conference numbers belonging to a certain MCU a common prefix number. When the call is received at the MCU, the MCU recognizes the number as a personal conference number, and is thereby pre-instructed to automatically set up a multipart call. In the first phase, this means that an encoder resource is set aside for the conference, but the personal conference number could also be associated with pre-settings e.g. defining that a certain amount of resources (e.g. encoders/decoders) should be booked and bit rates should be set as the call from the first participant is received at the MCU.

When the second call initiated by the same personal conference number is received at the MCU, a decoder resource for both the participants is allocated (if not already allocated) and a call between the two participants are established through the MCU in a conventional way. The same is the case for the next incoming calls using the number, but in this case also to establish required functionalities for a conference including more than two participants, such as Continuous Presence and Voice Switching.

The resources are consecutively released as the participants leave the conference, and when the last participant is leaving, the conference is shut down, and the personal conference number is ready for new conferences.

The present invention is further exemplified in the following. As already indicated, the idea is to utilize the video conferencing capacity from a central conferencing bridge, developed for connecting multiple video endpoints into video conferences. The implementation will also utilize a number range available on the video conferencing bridge. In addition to the embodiment of the present invention described above, an alternative implementation of the present invention may also support a single number dial in.

The result will be the same. The central conferencing bridge will allocate resource and start a conference run time. When the last endpoint disconnect form the video conferences, the video bridge will automatically release the resources, and hence make it available for a new conference.

This allocation is implemented to be fully automated, and the conferencing users do not need to do any kind of conference setup and management. Now describing an example of a single number dial in, one common access point on the MCU must be configured. When a participant dials into this number, he is allowed to both create a personal pin code, and have a conference created, or to provide a given pin code to access an already created conference. If the conference is not created yet, the user is placed in a “waiting room” which is a hold state providing graphical information to the user allowing for DTMF inputs, until the correct conference, with the correct pin code is created. From the “waiting room”, the user may disconnect, try to re-dial the pin code or create an own conference at any time. The management for achieving this must be done by the video bridge administrator, setting up a number available for single number dial in, and by the conference host, distributing the conference pin codes.

As an example, the administrator makes the number MEET-8000 as the configured single number dial in number.

User A would like to host a conference with two other participants, User B and User C. User A sends an e-mail to User B and User C, saying: “Please dial into my conference. It will be hosted 10.00 am, the number is MEET-8000, and the pin code is 1976”.

Then, User C dials ‘MEET-8000’ at 09.55 am. He will be asked weather to create- or access a conference. User C chooses to access an already created conference, and provides the given pin code. Since User A has not yet started the conference, User C is told to wait until the conference is created. User C is placed in a waiting room.

User A dials ‘MEET-8000’, and chose to create a conference, at 09.58 am. User A is asked to provide a pin code for the conference, and User A enters ‘1976’. A conference is started dynamically. User C will now also dynamically be collected from the waiting room into the conference.

When User B dials ‘MEET-8000’ and provides the correct conference pin, all three are present in the conference, ready for multipoint conferencing.

A similar example when utilizing a personal conference number could be as follows.

User A has been assigned the number ‘USERA.meeting’. He may now at any time dial this number when he needs a multipart video conference. He can also distribute this number at any time, to anyone, since this is a static and personal number. When USER A will start a meeting with USER B and USER C, he distributes his personal number to them, and dials into ‘USERA.meeting’. No need for booking, setup and administration.

The idea of the concept is to use the potential number range on a conferencing bridge, to enable endpoints to automatically setup and connect to a multipart conferencing. This is facilitated by using simple interfaces as one system wide number, or a personal conference number.

The main advantage of the present invention is the increased availability of multipart conferencing, without the need of management, booking and administration. Now, simple endpoints may easily spawn a multipoint conference on the conferencing bridge, by dialling into a known number.

Abbreviations

| | |
|---|---|
| QCIF | Quarter Common Intermediate Format, part of the H.261. |
| | One quarter of the resolution of CIF |
| CIF | Common Intermediate Format part of the H.261 |
| DTMF | Dual Tone Multi-Frequency |
| Continuous | |
| Presence | |
| Voice | |
| Switching. | |

1. A method for establishing a conference between two or more multimedia terminals through a Multipoint Control Unit, MCU, characterized in that the method comprises at least the steps of:
a) pre-assigning and storing in the MCU one or more conference numbers respectively associated with a user or a multimedia terminal,
b) initiating a first call from a first multimedia terminal by dialling a first conference number among said one or more conference numbers,
c) route said first call to the MCU,
d) at receipt of the first call in the MCU, allocating primary MCU resources and establishing the conference including said first multimedia terminal,
e) initiating a second call from a second multimedia terminal by dialling said first conference number,
f) routing said second call to the MCU,
g) at receipt of the second call in the MCU, allocating secondary resources and including said second multimedia terminal in the conference.

2. The method according to claim 1, characterized in that the step of establishing the conference is only carried through if said first multimedia terminal is authorised to initiate establishment of the conference through said first conference number.

3. The method according to claim 1 or 2, characterized in that said primary MCU resources is an encoder and/or a decoder in the MCU.

4. The method according to claim 1, 2 or 3, characterized in that said secondary MCU resources is an encoder and/or a decoder in the MCU.

5. The method according to one of the preceding claims, characterized in that said first conference number is associated with a PIN code for authorising said first and second multimedia terminal access to the conference.

6. The method according to claim 1, characterized in that the method further comprises the step of:
initiating a third call from a third multimedia terminal by dialling said first conference number,
routing said third call initiated by the third multimedia terminal to the MCU, and
at receipt of the third call in the MCU, allocating resources and including said third multimedia terminal in the conference.

7. The method according to claim 1, characterized in that the method further comprises the step of:
respectively initiating a number of calls from a number of multimedia terminals, each call being associated to a single multimedia terminal by dialling said first conference number,
respectively routing said number of calls initiated by the number of multimedia terminals to the MCU, and
at receipt of each of the number of calls in the MCU, allocating resources and respectively including said number of multimedia terminals in the conference.

8. The method according to any of the claims 6 or 7, characterized in allocating required functionalities for a conference including more than two participants, such as Continuous Presence and Voice Switching.
